(19) United States
(12) Patent Application Publication
(10) Pub. No.: US 2025/0067965 A1
(43) Pub. Date: Feb. 27, 2025

(54) OPTICAL SYSTEM AND IMAGE PICKUP APPARATUS

(71) Applicant: CANON KABUSHIKI KAISHA, Tokyo (JP)

(72) Inventors: Akira MIZUMA, Saitama (JP); Yuichi KOSAKA, Tochigi (JP); Fumihiro SHINOBU, Tochigi (JP)

(21) Appl. No.: 18/804,216

(22) Filed: Aug. 14, 2024

(30) Foreign Application Priority Data
Aug. 24, 2023 (JP) 2023-136137

(51) Int. Cl. G02B 15/14; H04N 13/239

(52) U.S. Cl. CPC G02B 15/1425; H04N 13/239

(57) ABSTRACT

An optical system includes a first optical system configured to form an optical image of an object in a first imaging area, and a second optical system disposed in parallel with the first optical system and configured to form an optical image of the object in a second imaging area. Each of the first optical system and the second optical system includes an aperture stop fixed in an optical axis direction relative to a position of an image plane, and a lens unit disposed on an image plane side of the aperture stop and movable in the optical axis direction. A predetermined inequality is satisfied.

### BACKGROUND

### Technical Field

One of the aspects of the embodiments relates to an optical system and an image pickup apparatus.

### Description of Related Art

Japanese Patent Laid-Open No. 2012-3022 discloses a stereoscopic imaging optical system that uses two optical systems arranged in parallel to form two optical images side by side on a single image sensor and capture realistic images such as virtual reality.

In the stereoscopic imaging optical system disclosed in Japanese Patent Laid-Open No. 2012-3022, the two optical systems arranged in parallel to each other have fixed deep focus during focusing. Thus, this optical system has a large aperture value (F-number) and difficulty in acquiring blurred images, and is not suitable as a stereoscopic imaging optical system.

### SUMMARY

An optical system according to one aspect of the disclosure includes a first optical system configured to form an optical image of an object in a first imaging area, and a second optical system disposed in parallel with the first optical system and configured to form an optical image of the object in a second imaging area. Each of the first optical system and the second optical system includes an aperture stop fixed in an optical axis direction relative to a position of an image plane. At least one of the first optical system and the second optical system includes a lens unit disposed on an image plane side of the aperture stop and movable in the optical axis direction. The following inequality is satisfied:
0.30<Φs/DL<0.90
   Φs is a diameter of the aperture stop configured to determine an on-axis light beam of each of the first optical system and the second optical system, and DL is a distance between an optical axis that passes a lens closest to the object of the first optical system and an optical axis that passes a lens closest to the object of the second optical system. An image pickup apparatus having the above optical system also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of an optical system according to Example 1.

FIG. 2 is an aberration diagram of the optical system according to Example 1.

FIG. 3 is a sectional view of an optical system according to Example 2.

FIG. 4 is an aberration diagram of the optical system according to Example 2.

FIG. 5 is a sectional view of an optical system according to Example 3.

FIG. 6 is an aberration diagram of the optical system according to Example 3.

FIG. 7 is a sectional view of an optical system according to Example 4.

FIG. 8 is an aberration diagram of the optical system according to Example 4.

FIG. 9 is a sectional view of a lens apparatus having two optical systems according to each example.

FIG. 10 is a schematic diagram of an image circle on an image sensor in each example.

FIG. 11 is a schematic diagram of an image pickup apparatus according to each example.

### DESCRIPTION OF THE EMBODIMENTS

Referring now to the accompanying drawings, a detailed description will be given of embodiments according to the disclosure.

An optical system according to each example is a stereoscopic imaging optical system in which two optical systems are arranged in parallel for a single image sensor to obtain a stereoscopically visible image. FIG. 9 is a sectional view of a lens apparatus (optical system) LA having an optical system (first optical system) OS1 and an optical system (second optical system) OS2 in each example. As illustrated in FIG. 9, the lens apparatus LA according to each example includes two optical systems OS1 and OS2, and the two optical systems OS1 and OS2 are arranged in parallel for an imaging surface (image plane IP) of an image sensor. The optical systems OS1 and OS2 are spaced by a distance (base length) DL between an optical axis OA1 of the optical system OS1 and an optical axis OA2 of the optical system OS2. The two optical systems OS1 and OS2 are held by an unillustrated housing.

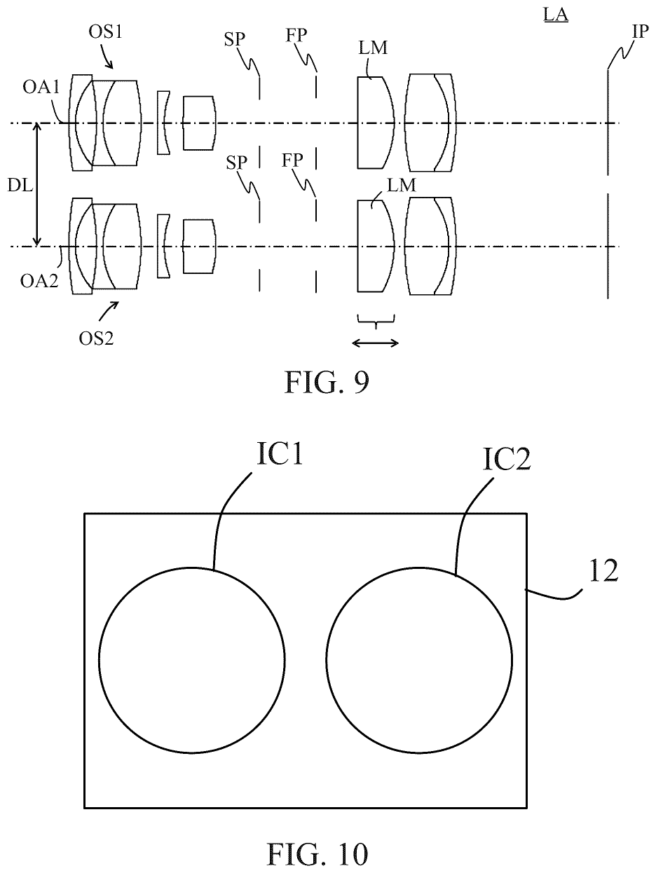

FIG. 10 is a schematic diagram of an image circle formed on an image sensor 12, and illustrates a state in which light rays incident on two optical systems OS1 and OS2 are imaged into image circles IC1 and IC2 of the two optical systems OS1 and OS2 within the single image sensor 12. As illustrated in FIG. 10, an image circle (first imaging area) IC1 corresponding to the optical system OS1 and an image circle (second imaging area) IC2 corresponding to the optical system OS2 are arranged in parallel on the imaging surface of the single image sensor 12. Images (optical images) are formed on the image plane IP of the image sensor 12 by the optical systems OS1 and OS2. That is, the lens apparatus LA according to each example forms two optical images by the two optical systems OS1 and OS2 on the single image sensor 12.

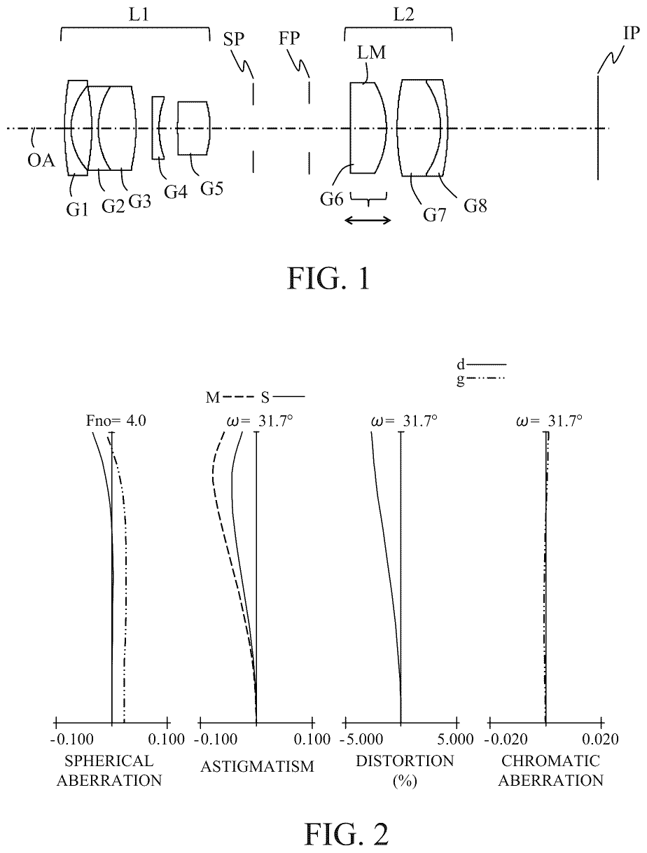

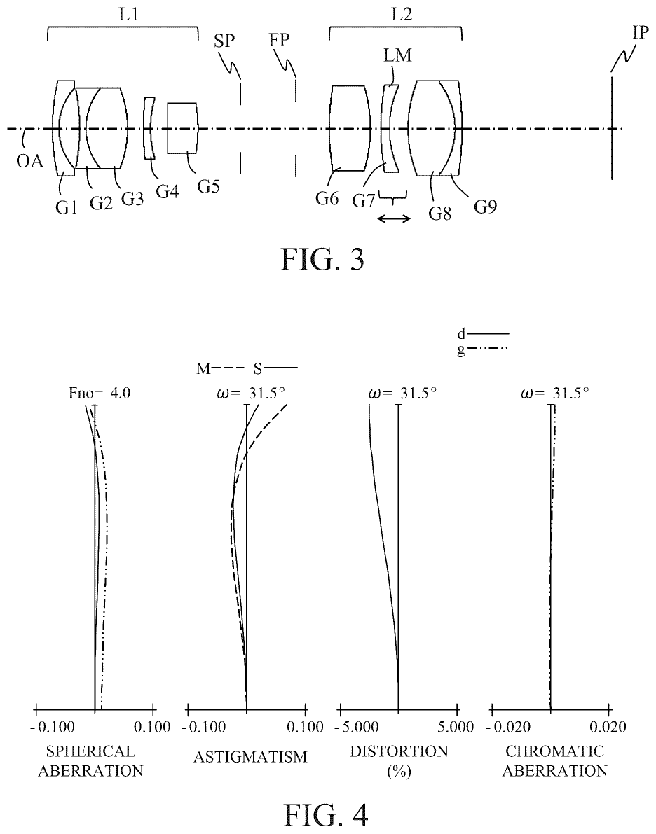

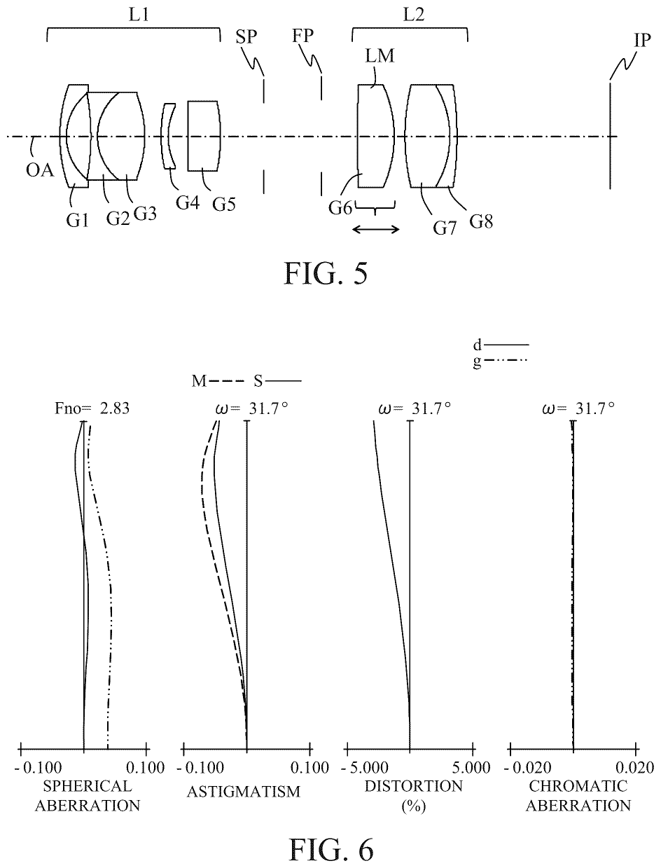

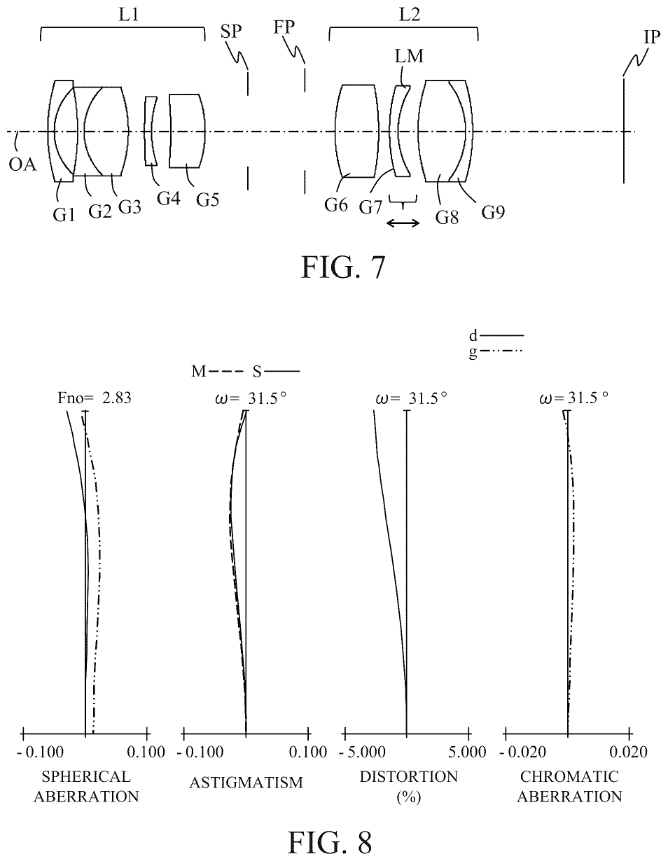

A description will now be given of an optical system according to each example. FIGS. 1, 3, 5, and 7 are sectional views of the optical systems according to Examples 1 to 4 (one of the first optical system and the second optical system). In each sectional view, the left side is an object side (front) and the right side is an image side (rear). The optical system according to each example includes a plurality of lens units. The lens unit may include one or more lenses. The lens unit may also include an aperture stop.

In each sectional view, SP represents an aperture stop. FP represents a flare-cut diaphragm that cuts out unnecessary light. IP represents an image plane. In a case where the optical system according to each example is used as an imaging optical system for a digital still camera or digital video camera, the imaging surface of a photoelectric conversion element such as a CCD sensor or a CMOS sensor is placed on the image plane IP. In a case where the optical system according to each example is used as an imaging optical system for a film-based camera, a photosensitive surface corresponding to the film plane is placed on the image plane IP. In the optical system according to each example, an optical block (not illustrated) corresponding to an optical filter, a face plate, a low-pass filter, or an infrared cut filter may be placed on the object side of the image plane IP.

FIGS. 2, 4, 6, and 8 are aberration diagrams of the optical systems according to Examples 1 to 4 in an in-focus state at infinity, respectively. In the spherical aberration diagram, Fno represents an F-number, and the spherical aberration diagram illustrates a spherical aberration amount for the d-line (wavelength 587.6 nm) and g-line (wavelength 435.8 nm). In the astigmatism diagram, ΔS represents an astigmatism amount on a sagittal image plane, and AM illustrates an astigmatism amount on a meridional image plane. The distortion aberration diagram illustrates a distortion amount for the d-line. The chromatic aberration diagram illustrates a chromatic aberration amount for the g-line. ω represents a half angle of view (°).

The optical system according to each example illustrates an example in which an image sensor has a base length of 11.7 mm, a short side length of 15 mm, and a long side length of 22.4 mm. The image circle diameter of each optical system is set to 9.7 mm, and a 2 mm gap is set between the image circles of the two optical systems (the first optical system and the second optical system). In this case, a distance between the vertices of the lens surfaces of the two optical systems is 11.7 mm. The image circle of each optical system is separated by 0.5 mm from the short side of the image sensor 12. Thereby, the lens apparatus 11 according to each example can accommodate the image circles in the single image sensor 12. The optical system according to each example is assumed to have the image sensor 12 with a short side length of 15 mm and a long side length of 22.4 mm, which is generally used for lens interchangeable type cameras, but is not limited to this example and is applicable to cameras with image sensors of various sizes. The distance between the two image circles can also be arbitrarily set. The optical system according to each example employs a central projection method, but various projection methods such as an equiangular projection method, an equisolid angle projection method, or a stereoscopic projection method may also be employed.

A description will now be given of a characteristic configuration of the optical system according to each example. The optical system according to each example includes, in order from the object side to the image side, a first lens unit (front group) having negative refractive power, an aperture stop SP, and a second lens unit (rear group) having positive refractive power. Such a so-called retrofocus type refractive power arrangement consisting of a front group having negative refractive power and a rear group having positive refractive power as a whole can realize a compact size and a wide angle of view.

In order to experience a realistic three-dimensional image, the optical system according to each example includes a large-diameter lens that is expected to have an effect on the three-dimensional image by visual blur. Generally, a large-diameter lens increases a size of the optical system. In addition, a large-diameter lens narrows a focal depth, so focus accuracy according to an imaging distance of an object is required. Thus, the optical system according to each example has a lens unit (intermediate lens unit) LM disposed on the image plane IP side of the aperture stop SP and configured to move to equalize (or adjust a difference between) the two image plane positions. Thereby, a shift between the left and right image planes caused by manufacturing variations can be equalized, and a difference between the left and right visions for each individual can be corrected.

In addition, the aperture stop SP in the optical system according to each example is not included in the intermediate lens unit, but is disposed at a fixed position in a direction along the optical axis OA (optical axis direction) relative to the image plane IP. Thereby, even with a large-diameter lens, a driving unit for the variable aperture stop SP and a driving unit for the intermediate lens unit that moves on the optical axis OA can be separately provided, and a compact and lightweight image pickup apparatus can be realized.

The optical system according to each example is an overall focus type in which the entire optical system moves in the optical axis direction during (or for) focusing from infinity to a close distance, or an inner focus type in which some lenses of the optical system move in the optical axis direction. In the optical system according to each example, the lens unit LM can be used not as an intermediate lens unit, but as a focus unit that moves in the optical axis direction during (or for) focusing from infinity to a close distance. Such a combination of the intermediate lens unit and the focus unit can realize a small and lightweight image pickup apparatus.

The following inequality (1) is satisfied:

$$0.25 < {Φ}_{S} / DL < 0.9 \qquad ( 1 )$$

where Φs is a diameter of the aperture stop SP that determines an on-axis light beam of each of the first optical system (optical system OA1) and the second optical system (optical system OA2), and DL is a distance (base length) between the optical axis OA1 of the first optical system and the optical axis OA2 of the second optical system. More specifically, DL is a distance between the optical axis OA1 that passes a lens closest to an object of the first optical system and the optical axis OA2 that passes a lens closest to an object of the second optical system.

Inequality (1) defines a ratio between the diameter of the aperture stop SP that determines an on-axis light beam of each of the first and second optical systems and a distance (base length) between the first and second optical systems. In a case where the value becomes lower than the lower limit of inequality (1), the diameter Φs of the aperture stop SP of each of the first and second optical systems reduces, the F-number excessively increases, and it becomes difficult to obtain a blurred image. As a result, the visual blur effect of the image obtained by the two optical systems reduces, and a three-dimensional effect cannot be obtained. On the other hand, in a case where the value becomes higher than the upper limit of inequality (1), the diameter Φs of the aperture stop SP of each of the first and second optical systems excessively increases, and the size of each optical system according to each example increases, and adjacent lenses may interfere with each other.

Inequality (1) may be replaced with inequality (1a) below:

$$0.3 < Φ s / D L < 0.80 \qquad ( 1 a )$$

Inequality (1) may be replaced with inequality (1b) below:

$$0.35 < Φs / D L < 0.60 \qquad ( 1 b )$$

The above configuration can provide a small, lightweight, high-performance optical system capable of stereoscopic imaging in which imaging using two optical systems is performed by a single image sensor.

A description will now be given of conditions and configurations that may be satisfied by the optical system according to each example. At least one of the two optical systems may satisfy the conditions and configurations described below. Both the two optical systems may satisfy the conditions and configurations described below, for example by equalizing the configurations of the two optical systems.

The optical system according to each example may satisfy the following inequality (2):

$$0.4 < L m / L s < 0.90 \qquad ( 2 )$$

where Ls is a distance on the optical axis from the aperture stop SP to the image plane IP, and Lm is a distance on the optical axis from the foremost surface (the surface closest to the object) of the lens unit LM (intermediate lens unit or focus unit) in an in-focus state at infinity to the image plane IP.

Inequality (2) defines an arrangement of the aperture stop SP and the lens unit LM. In a case where the value becomes lower than the lower limit of inequality (2), a distance between the aperture stop SP and the lens unit LM increases, and the size of the lens unit LM increases. On the other hand, in a case where the value becomes higher than the upper limit of inequality (2), a distance between the aperture stop SP and the lens unit LM decreases, and the drive units that mechanically operate various components interfere with each other.

Inequality (2) may be replaced with inequality (2a) below:

$$0.5 < L m / L s < 0.80 \qquad ( 2 a )$$

Inequality (2) may be replaced with inequality (2b) below:

$$0.6 < L m / L s < 0.75 \qquad ( 2 b )$$

The optical system according to each example may satisfy inequality (3) below:

$$1. 2 < \vert f m \vert / f < 6.0 \qquad ( 3 )$$

where fm is a focal length of the lens unit LM, and f is a focal length of the optical system (overall system).

Inequality (3) defines a ratio between the focal length of the lens unit LM and the focal length of the optical system. In a case where the value becomes lower than the lower limit of inequality (3), the refractive power of the lens unit becomes stronger, and the position sensitivity of the lens unit LM (a ratio between a moving amount of the lens unit LM and an associated change amount in back focus) increases, and it becomes difficult to equalize (or adjust a difference between) the left and right image plane positions. On the other hand, in a case where the value becomes higher than the upper limit of inequality (3), the refractive power of the lens unit LM becomes weak, so the position sensitivity of the lens unit LM (the ratio between the moving amount of the lens unit LM and the associated change in back focus) reduces, and the moving amount of the lens unit LM increases. As a result, the size of the optical system increases.

Inequality (3) may be replaced with inequality (3a) below:

$$1. 6 < \vert f m \vert / f < 5. \qquad ( 3 a )$$

Inequality (3) may be replaced with inequality (3b) below:

$$2. < \vert f m \vert / f < 4.5 \qquad ( 3 b )$$

In the optical system according to each example, the lens unit LM may have negative refractive power. Thereby, the diameter, overall length, and weight of the lens unit LM are reduced. As a result, the drive unit that moves the lens unit LM during (or for) focusing can be simplified, and the size reduction can be promoted. In addition, properly setting the refractive power of the lens unit LM as a focus unit can achieve a balance between suppression of aberration fluctuations associated with object distance changes and proper focus sensitivity.

In the optical system according to each example, the lens unit LM may include a negative meniscus lens with a convex surface facing the object side. Thereby, aberration fluctuations (particularly spherical aberration fluctuations) when the lens unit LM moves on the optical axis can be reduced.

In the optical system according to each example, the lens unit LM may consist of a single lens. Thereby, the weight of the lens unit LM can be further reduced, and the drive unit that moves it during focusing can be simpler and smaller. Properly setting the curvature of the lens surface of the lens unit LM as a focus unit can improve the image plane characteristic at a close distance.

In the optical system according to each example, the following inequality (4) may be satisfied:

$$0.5 < L s / L T < 0.80 \qquad ( 4 )$$

where Ls is a distance on the optical axis from the aperture stop SP to the image plane IP, and LT is a distance on the optical axis from the lens surface closest to the object to the image plane IP.

Inequality (4) defines a ratio between the distance on the optical axis from the aperture stop SP to the image plane IP and the overall length of the optical system. As illustrated in FIG. 10, in order to image the image circles IC1 and IC2 of the two optical systems onto the single image sensor 12, the lenses are to be arranged in parallel and close to each other. In a case where the value becomes lower than the lower limit of inequality (4), the aperture stop SP becomes excessively close to the image plane, the lens diameter on the object side increases, the weight may increase, and adjacent lenses may interference with each other. On the other hand, in a case where the value becomes higher than the upper limit of inequality (4), the aperture stop SP becomes excessively close to the object side, which increases the lens diameter on the object, the lens diameter on the image side increases, and adjacent lenses may interference with each other.

Inequality (4) may be replaced with inequality (4a) below:

$$0.55 < L s / L T < 0.75 \qquad ( 4 a )$$

Inequality (4) may be replaced with inequality (4b) below:

$$0.6 < L s / L T < 0.70 \qquad ( 4 b )$$

The optical system according to each example may satisfy inequality (5) below:

$$4. < L T / f < 10.0 \qquad ( 5 )$$

where LT is a distance on the optical axis from the lens surface closest to the object to the image plane IP, and f is a focal length of the optical system (overall system).

Inequality (5) defines a ratio between the overall optical length and the focal length of the optical system. In a case where the value becomes lower than the lower limit of inequality (5), the overall optical length decreases, the distance between the aperture stop SP and the lens unit LM reduces, and the drive units that mechanically operate them may interfere with each other. On the other hand, in a case where the value becomes higher than the upper limit of inequality (5), the overall optical length increases, and the size of the optical system increases.

Inequality (5) may be replaced with inequality (5a) below:

$$5. 0 < L T / f < 8. \qquad ( 5 a )$$

Inequality (5) may be replaced with inequality (5b) below:

$$6. < L T / f < 7.0 \qquad ( 5 b )$$

The optical system according to each example may satisfy inequality (6) below:

$$1. 2 < \vert f n \vert / f < 15. \qquad ( 6 )$$

where fn is a focal length of the front group disposed on the object side of the aperture stop SP, and f is a focal length of the optical system (overall system).

Inequality (6) defines a ratio between the focal length of the front group disposed on the object side of the aperture stop SP, and the focal length of the optical system. In a case where the value becomes lower than the lower limit of inequality (6), the refractive power of the front group becomes too strong, and it becomes difficult to effectively correct aberrations such as curvature of field and astigmatism. On the other hand, in a case where the value becomes higher than the upper limit of inequality (6), the refractive power of the front group becomes too weak, and the overall optical length and the size of the optical system increase.

Inequality (6) may be replaced with inequality (6a) below:

$$2. < \vert fn \vert / f < 10.0 \qquad ( 6 a )$$

Inequality (6) may be replaced with inequality (6b) below:

$$2.5 < \vert fn \vert / f < 8.0 \qquad ( 6 b )$$

In the optical system according to each example, the following inequality (7) may be satisfied:

$$0.8 < Φ f / Φ r < 1.2 \qquad ( 7 )$$

where Φf is an effective diameter of the lens disposed closest to the object, and Φr is an effective diameter of the lens disposed closest to the image plane. The effective diameter (effective area) is a diameter (area) on an optical surface through which effective light rays that contribute to imaging pass.

Inequality (7) defines a ratio between the effective diameter of the lens disposed closest to the object and the effective diameter of the lens disposed closest to the image plane. In a case where the value becomes lower than the lower limit of inequality (7), the lens diameter on the object side increases, which may result in an increase in weight and interference between adjacent lenses. On the other hand, in a case where the value becomes lower than the upper limit of inequality (7), the lens diameter on the image plane increases, which may result in interference between adjacent lenses.

Inequality (7) may be replaced with inequality (7a) below:

$$0.9 < Φ f / Φ r < 1.10 \qquad ( 7 a )$$

Inequality (7) may be replaced with inequality (7b) below:

$$0.95 < Φ f / Φ r < 1.05 \qquad ( 7 b )$$

The optical system according to each example may not include a reflective optical element that bends the optical path. Without the reflective optical element that increases the weight, the size and weight of the optical system can be reduced.

In the optical system according to each example, the lens unit LM that functions as an intermediate lens unit may be included in only one of the two optical systems. The left and right image plane positions can be equalized (adjusted) by moving only one of them along the optical axis, one of the drive mechanisms can be omitted, and the size and weight of the optical system can be reduced.

### Example 1

An optical system according to Example 1 includes, in order from the object side to the image side, a first lens unit (front group) L1 having negative refractive power, an aperture stop SP, and a second lens unit (rear group) L2 having positive refractive power. A flare-cut diaphragm FP configured to cut unnecessary light is disposed between the aperture stop SP and the second lens unit L2. The first lens unit L1 includes, in order from the object side to the image side, a negative meniscus lens G1 with a convex surface facing the object side, a cemented lens of a biconcave lens G2 and a biconvex lens G3, a negative meniscus lens G4 with a convex surface facing the object side, and a biconvex lens G5. The second lens unit L2 includes, in order from the object side to the image side, a positive meniscus lens G6 with a convex surface facing the image side, and a cemented lens of a biconvex lens G7 and a negative meniscus lens G8 with a convex surface facing the image side. In this example, the positive meniscus lens G6 is a lens unit LM that moves in the optical axis direction as an intermediate lens unit or a focus unit.

### Example 2

An optical system according to Example 2 includes, in order from the object side to the image side, a first lens unit (front group) L1 having negative refractive power, an aperture stop SP, and a second lens unit (rear group) L2 having positive refractive power. A flare-cut diaphragm FP configured to cut unnecessary light is disposed between the aperture stop SP and the second lens unit L2. The first lens unit L1 includes, in order from the object side to the image side, a negative meniscus lens G1 with a convex surface facing the object side, a cemented lens of a biconcave lens G2 and a biconvex lens G3, a negative meniscus lens G4 with a convex surface facing the object side, and a positive meniscus lens G5 with a convex surface facing the image side. The second lens unit L2 includes, in order from the object side, a biconvex lens G6, a negative meniscus lens G7 with a convex surface facing the object side, and a cemented lens of a biconvex lens G8 and a negative meniscus lens G9 with a convex surface facing the image side. In this example, the negative meniscus lens G7 is a lens unit LM that moves in the optical axis direction as an intermediate lens unit or a focus unit.

### Example 3

An optical system according to Example 3 includes, in order from the object side to the image side, a first lens unit (front group) L1 having negative refractive power, an aperture stop SP, and a second lens unit (rear group) L2 having positive refractive power. A flare cut diaphragm FP configured to cut unnecessary light is disposed between the aperture stop SP and the second lens unit L2. The first lens unit L1 includes, in order from the object side, a negative meniscus lens G1 with a convex surface facing the object side, a cemented lens of a biconcave lens G2 and a biconvex lens G3, a negative meniscus lens G4 with a convex surface facing the object side, and a biconvex lens G5. The second lens unit L2 includes, in order from the object side, a positive meniscus lens G6 with a convex surface facing the image side, and a cemented lens of a biconvex lens G7 and a negative meniscus lens G8 with a convex surface facing the image side. In this example, the positive meniscus lens G6 is a lens unit LM that moves in the optical axis direction as an intermediate lens unit or a focus unit.

### Example 4

An optical system according to Example 4 includes, in order from the object side to the image side, a first lens unit (front group) L1 having negative refractive power, an aperture stop SP, and a second lens unit (rear group) L2 having positive refractive power. A flare-cut diaphragm FP configured to cut unnecessary light is disposed between the aperture stop SP and the second lens unit L2. The first lens unit L1 includes, in order from the object side, a negative meniscus lens G1 with a convex surface facing the object side, a cemented lens of a biconcave lens G2 and a biconvex lens G3, a negative meniscus lens G4 with a convex surface facing the object side, and a positive meniscus lens G5 with a convex surface facing the image side. The second lens unit L2 includes, in order from the object side, a biconvex lens G6, a negative meniscus lens G7 with a convex surface facing the object side, and a cemented lens of a biconvex lens G8 and a negative meniscus lens G9 with a convex surface facing the image side. In this example, the negative meniscus lens G6 is a lens unit LM that moves in the optical axis direction as an intermediate lens unit or a focus unit.

A description will now be given of numerical examples 1 to 4 corresponding to Examples 1 to 4, respectively. In surface data in each numerical example, r represents a radius of curvature of each optical surface, and d (mm) represents an on-axis distance (distance on the optical axis) between m-th and (m+1)-th surfaces, where m is a surface number counted from the light incident side. nd represents a refractive index of each optical member for the d-line, and vd represents the Abbe number of the optical member. The Abbe number vd of a certain material is expressed as follows:

$$v d = ( N d - 1 ) / ( NF - N C )$$

where Nd, NF, and NC are refractive indices for the d-line (587.6 nm), F-line (486.1 nm), and C-line (656.3 nm) in the Fraunhofer lines, respectively.

In each numerical example, all of d, focal length (mm), F-number (Fno), and half angle of view (°) are values in a case where the optical system according to each example is in an in-focus state on an object at infinity. A “back focus (BF)” is a distance on the optical axis from a final lens surface (a lens surface closest to the image plane) to a paraxial image plane expressed in air-equivalent length. An “overall lens length” is a distance on the optical axis from the foremost lens surface (the lens surface closest to the object) of the optical system to the final surface plus the back focus. A “lens unit” includes one or more lenses.

Numerical examples 1 to 4 use an overall focus method in which the entire optical system is moved along the optical axis during (or for) focusing from infinity to a close distance, or an inner focus method in which some lenses in the optical system are driven along the optical axis.

In a case where an optical surface is aspheric, an asterisk * is added to the right shoulder of the surface number. The aspheric shape is expressed as follows:

$$x = ( {h}^{2} / R ) / [ 1 + {\{ 1 - ( 1 + k ) {( h / R )}^{2} \}}^{1 / 2} ] + A 4 \times {h}^{4} + A 6 \times {h}^{6} + A 8 \times {h}^{8} + A 10 \times {h}^{10}$$

where x is a displacement amount from a surface vertex in the optical axis direction, h is a height from the optical axis in a direction orthogonal to the optical axis, R is a paraxial radius of curvature, k is a conic constant, and A4, A6, A8, and A10 are aspheric coefficients of each order. “e±XX” in each aspheric coefficient means “×10^{±XX}.”

### Numerical Example 1

UNIT: mm

| | SURFACE DATA | | | | |
|---|---|---|---|---|---|
| Surface No. | r | d | nd | νd | Effective Diameter |
| 1 | 28.037 | 0.60 | 2.00069 | 25.5 | 8.00 |
| 2 | 5.787 | 1.93 | | | 6.93 |
| 3 | −19.572 | 0.60 | 1.49700 | 81.7 | 6.89 |
| 4 | 7.267 | 3.51 | 1.91082 | 35.2 | 7.03 |
| 5 | −16.549 | 1.50 | | | 6.63 |
| 6 | 166.655 | 0.65 | 1.95375 | 32.3 | 5.16 |
| 7 | 8.072 | 1.73 | | | 4.76 |
| 8 | 41.661 | 3.02 | 1.57501 | 41.5 | 4.48 |
| 9 | −8.820 | 3.98 | | | 4.12 |
| 10 (SP) | ∞ | 5.26 | | | 4.30 |
| 11 | ∞ | 3.80 | | | 4.57 |
| 12 | −15241.459 | 3.37 | 1.48749 | 70.2 | 6.70 |
| 13 | −8.757 | 1.00 | | | 7.62 |
| 14 | 21.636 | 4.06 | 1.49700 | 81.7 | 7.83 |
| 15 | −7.441 | 0.65 | 2.00100 | 29.1 | 7.67 |
| 16 | −21.631 | 14.01 | | | 8.00 |
| Image Plane | ∞ | | | | |

VARIOUS DATA

| | |
|---|---|
| Focal Length | 7.85 |
| Fno | 4.00 |
| Half Angle of View | 31.70 |
| Image Height | 4.85 |
| Overall Lens Length | 49.69 |
| BF | 14.01 |

| Lens Unit | Focal Length |
|---|---|
| 1 | −59.88 |
| 2 | 16.35 |

### Numerical Example 2

UNIT: mm

| | SURFACE DATA | | | | |
|---|---|---|---|---|---|
| Surface No. | r | d | nd | νd | Effective Diameter |
| 1 | 20.138 | 0.60 | 2.00100 | 29.1 | 8.00 |
| 2 | 5.616 | 1.95 | | | 6.90 |
| 3 | −19.992 | 0.60 | 1.49700 | 81.5 | 6.83 |
| 4 | 5.919 | 3.92 | 1.63930 | 44.9 | 6.87 |
| 5 | −10.172 | 1.50 | | | 6.63 |
| 6 | 31.880 | 0.65 | 1.85150 | 40.8 | 5.15 |
| 7 | 9.585 | 1.64 | | | 4.79 |
| 8 | −94.113 | 2.84 | 1.59551 | 39.2 | 4.30 |
| 9 | −13.790 | 3.98 | | | 4.08 |
| 10 (SP) | ∞ | 5.26 | | | 4.52 |
| 11 | ∞ | 3.13 | | | 5.07 |
| 12 | 22.574 | 3.88 | 1.59282 | 68.6 | 6.52 |
| 13 | −13.815 | 1.00 | | | 7.24 |
| 14 | 25.300 | 0.80 | 1.48749 | 70.2 | 7.33 |
| 15 | 9.663 | 1.76 | | | 7.25 |
| 16 | 12.218 | 4.42 | 1.49700 | 81.5 | 7.77 |
| 17 | −7.057 | 0.65 | 1.78880 | 28.4 | 7.71 |
| 18 | −29.882 | 14.13 | | | 8.00 |
| Image Plane | ∞ | | | | |

VARIOUS DATA

| | |
|---|---|
| Focal Length | 7.90 |
| Fno | 4.00 |
| Half Angle of View | 31.54 |
| Image Height | 4.85 |
| Overall Lens Length | 52.72 |
| BF | 14.13 |

| Lens Unit | Focal Length |
|---|---|
| 1 | −20.88 |
| 2 | 15.72 |

### Numerical Example 3

UNIT: mm

| | SURFACE DATA | | | | |
|---|---|---|---|---|---|
| Surface No. | r | d | nd | νd | Effective Diameter |
| 1 | 13.855 | 0.60 | 1.95375 | 32.3 | 8.46 |
| 2 | 5.030 | 2.25 | | | 7.12 |
| 3 | −21.266 | 0.60 | 1.49700 | 81.7 | 7.06 |
| 4 | 5.046 | 4.32 | 1.60311 | 60.6 | 7.11 |
| 5 | −10.266 | 1.50 | | | 6.86 |
| 6 | 13.881 | 0.65 | 1.72916 | 54.7 | 5.29 |
| 7 | 6.070 | 1.79 | | | 4.80 |
| 8 | 230.213 | 2.99 | 1.85400 | 40.4 | 5.16 |
| 9* | −17.387 | 3.98 | | | 5.77 |
| 10 (SP) | ∞ | 5.26 | | | 6.14 |
| 11 | ∞ | 3.29 | | | 6.60 |
| 12 | 98.564 | 3.37 | 1.58913 | 61.1 | 7.55 |
| 13 | −11.342 | 0.99 | | | 8.37 |
| 14 | 19.942 | 4.10 | 1.49700 | 81.7 | 8.52 |
| 15 | −8.945 | 0.65 | 2.00069 | 25.5 | 8.25 |
| 16 | −30.904 | 14.01 | | | 8.50 |
| Image Plane | ∞ | | | | |

ASPHERIC DATA
9th Surface
K = 0.00000e+00 A 4 = −2.04444e−04
A 6 = −6.25786e−06 A 8 = 1.41069e−07
VARIOUS DATA

| | |
|---|---|
| Focal Length | 7.87 |
| Fno | 2.83 |
| Half Angle of View | 31.65 |
| Image Height | 4.85 |
| Overall Lens Length | 50.36 |
| BF | 14.01 |

| Lens Unit | Focal Length |
|---|---|
| 1 | −42.20 |
| 2 | 15.86 |

### Numerical Example 4

UNIT: mm

| | SURFACE DATA | | | | |
|---|---|---|---|---|---|
| Surface No. | r | d | nd | νd | Effective Diameter |
| 1 | 16.651 | 0.60 | 2.00100 | 29.1 | 8.51 |
| 2 | 5.479 | 2.16 | | | 7.27 |
| 3 | −21.209 | 0.60 | 1.49700 | 81.5 | 7.21 |
| 4 | 5.714 | 4.11 | 1.64850 | 53.0 | 7.29 |
| 5 | −12.045 | 1.50 | | | 7.03 |
| 6 | 50.739 | 0.65 | 1.72916 | 54.7 | 5.67 |
| 7 | 9.755 | 1.79 | | | 5.28 |
| 8 | −29.566 | 3.18 | 1.59270 | 35.3 | 5.14 |
| 9 | −10.320 | 3.98 | | | 6.01 |
| 10 (SP) | ∞ | 5.26 | | | 6.61 |
| 11 | ∞ | 2.79 | | | 7.32 |
| 12* | 13.453 | 4.06 | 1.59522 | 67.7 | 7.77 |
| 13 | −21.615 | 1.00 | | | 7.56 |
| 14 | 15.251 | 0.80 | 1.80400 | 46.6 | 7.51 |
| 15 | 7.680 | 1.85 | | | 7.21 |
| 16 | 14.574 | 4.41 | 1.49700 | 81.5 | 7.88 |
| 17 | −7.343 | 0.65 | 1.77830 | 23.9 | 8.14 |
| 18 | −16.364 | 14.01 | | | 8.51 |
| Image Plane | ∞ | | | | |

ASPHERIC DATA
12th Surface
K = 0.00000e+00 A 4 −8.14887e−06
A 6 = −7.31987e−10 A 8 = −1.40629e−08
VARIOUS DATA

| | |
|---|---|
| Focal Length | 7.91 |
| Fno | 2.83 |
| Half Angle of View | 31.53 |
| Image Height | 4.85 |
| Overall Lens Length | 53.40 |
| BF | 14.01 |

| Lens Unit | Focal Length |
|---|---|
| 1 | −25.79 |
| 2 | 16.66 |

Various values in each numerical example are summarized in the following Table 1. In all examples, the d-line is used as a reference wavelength, and the values in Table 1 are illustrated for the reference wavelength.

TABLE 1

| | Example 1 | Example 2 | Example 3 | Example 4 |
|---|---|---|---|---|
| f | 7.85 | 7.90 | 7.87 | 7.91 |
| fn | −59.88 | −20.88 | −42.20 | −25.79 |
| Φs | 4.30 | 4.52 | 6.14 | 6.61 |
| DL | 11.7 | 11.7 | 11.7 | 11.7 |
| LT | 49.69 | 52.72 | 50.36 | 53.40 |
| Ls | 32.16 | 35.03 | 31.68 | 34.83 |
| Lm | 23.09 | 21.77 | 23.13 | 21.73 |
| Lc | 23.09 | 21.77 | 23.13 | 21.73 |
| fm | 17.97 | −32.62 | 17.46 | −20.19 |
| fc | 17.97 | −32.62 | 17.46 | −20.19 |
| Φf | 8.00 | 8.00 | 8.46 | 8.51 |
| Φr | 8.00 | 8.00 | 8.50 | 8.51 |
| Inequality (1) | 0.368 | 0.386 | 0.525 | 0.565 |
| Inequality (2) | 0.718 | 0.621 | 0.730 | 0.624 |
| Inequality (3) | 2.288 | 4.128 | 2.220 | 2.554 |
| Inequality (4) | 0.647 | 0.664 | 0.629 | 0.652 |
| Inequality (5) | 6.327 | 6.671 | 6.400 | 6.755 |
| Inequality (6) | 7.625 | 2.642 | 5.363 | 3.262 |
| Inequality (7) | 1.000 | 1.000 | 0.995 | 0.999 |

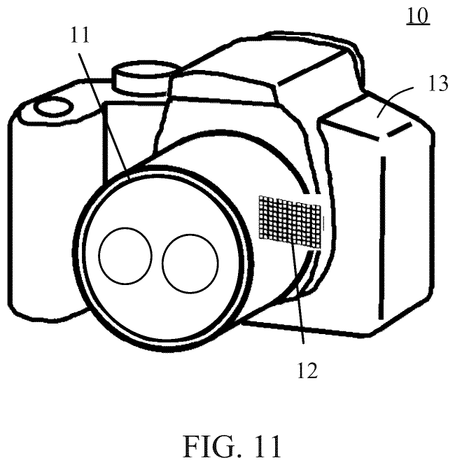

Referring now to FIG. 11, a description will be given of an image pickup apparatus 10 having the optical system according to any one of the above examples. FIG. 11 is a schematic diagram of the image pickup apparatus (digital still camera) 10. The image pickup apparatus 10 includes a camera body 13 having an image sensor 12, and a lens apparatus 11 having any one of the optical systems according to Examples 1 to 4. The lens apparatus 11 and the camera body 13 may be integrated or detachably configured. The camera body 13 may be a so-called single-lens reflex camera having a quick-turn mirror, or may be a so-called mirrorless camera having no quick-turn mirror. The image sensor 12 is a photoelectric conversion element such as a CCD (Charge Coupled Device) sensor or a CMOS (Complementary Metal-Oxide-Semiconductor) sensor configured to photoelectrically convert an optical image formed by the optical system. The image pickup apparatus 10 according to each example includes a lens apparatus 11, and performs stereoscopic imaging using two optical systems OS1 and OS2 with the single small image sensor 12. The optical system according to each example is not limited to the digital still camera illustrated in FIG. 11, but is also applicable to various image pickup apparatuses such as broadcasting cameras, film-based cameras, or surveillance cameras.

Each example can provide a small optical system and image pickup apparatus that can properly perform stereoscopic imaging.

While the disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2023-136137, which was filed on Aug. 24, 2023, and which is hereby incorporated by reference herein in its entirety.

What is claimed is:

1. An optical system comprising:
a first optical system configured to form an optical image of an object in a first imaging area; and
a second optical system disposed in parallel with the first optical system and configured to form an optical image of the object in a second imaging area,
wherein each of the first optical system and the second optical system includes an aperture stop fixed in an optical axis direction relative to a position of an image plane, and at least one of the first optical system and the second optical system includes a lens unit disposed on an image plane side of the aperture stop and movable in the optical axis direction, and
wherein the following inequality is satisfied:
$$0.3 < Φ s / DL < 0.90$$
Φs is a diameter of the aperture stop configured to determine an on-axis light beam of each of the first optical system and the second optical system, and DL is a distance between an optical axis that passes a lens closest to the object of the first optical system and an optical axis that passes a lens closest to the object of the second optical system.

2. The optical system according to claim 1, wherein the lens unit is an intermediate lens unit configured to adjust a difference between a first image plane position of the optical image formed in the first imaging area by the first optical system and a second image plane position of the optical image formed in the second imaging area by the second optical system.

3. The optical system according to claim 1, wherein each of the first optical system and the second optical system includes the lens unit, and the lens unit is configured to move for focusing from infinity to a close distance.

4. The optical system according to claim 1, wherein the following inequality is satisfied:
$$0. 40 < Lm / Ls < 0.90$$
where Ls is a distance on the optical axis from the aperture stop to the image plane, and Lm is a distance on the optical axis from a lens surface closest to the object of the lens unit in an in-focus state at infinity to the image plane.

5. The optical system according to claim 1, wherein the following inequality is satisfied:
$$1.2 < \vert fm \vert / f < 6.0$$
wherein fm is a focal length of the lens unit, and f is a focal length of the optical system.

6. The optical system according to claim 1, wherein the lens unit has negative refractive power.

7. The optical system according to claim 1, wherein the lens unit has a negative meniscus lens with a convex surface facing the object.

8. The optical system according to claim 1, wherein the lens unit consists of a single lens.

9. The optical system according to claim 1, wherein the following inequality is satisfied:
$$0.5 < Ls / LT < 0.80$$
where Ls is a distance on the optical axis from the aperture stop to the image plane, and LT is a distance on the optical axis from a lens surface closest to the object of the optical system to the image plane.

10. The optical system according to claim 1, wherein the following inequality is satisfied:
$$4. < LT / f < 10.0$$
where LT is a distance on the optical axis from a lens surface closest to the object of the optical system to the image plane, and f is a focal length of the optical system.

11. The optical system according to claim 1, wherein the following inequality is satisfied:
$$1. 2 < \vert fn \vert / f < 15.$$
where fn is a focal length of a front group disposed on an object side of the aperture stop, and f is a focal length of the optical system.

12. The optical system according to claim 1, wherein the following inequality is satisfied:
$$0.8 < Φ f / Φ r < 12.$$
where Φf is an effective diameter of a lens disposed closest to the object in the optical system, and Φr is an effective diameter of a lens disposed closest to the image plane.

13. The optical system according to claim 1, wherein the optical system does not include a reflective optical element configured to bend an optical path.

14. An image pickup apparatus comprising:
an optical system; and
an image sensor,
wherein the optical system includes:
a first optical system configured to form an optical image of an object in a first imaging area; and
a second optical system disposed in parallel with the first optical system and configured to form an optical image of the object in a second imaging area,
wherein each of the first optical system and the second optical system includes an aperture stop fixed in an optical axis direction relative to a position of an image plane, and at least one of the first optical system and the second optical system includes a lens unit disposed on an image plane side of the aperture stop and movable in the optical axis direction, and
wherein the following inequality is satisfied:
$$0.3 < Φ s / DL < 0.90$$
Φs is a diameter of the aperture stop configured to determine an on-axis light beam of each of the first optical system and the second optical system, and DL is a distance between an optical axis that passes a lens closest to the object of the first optical system and an optical axis that passes a lens closest to the object of the second optical system.

15. The image pickup apparatus according to claim 14, wherein the first imaging area and the second imaging area are imaging areas on a single image sensor.
